(19) United States
(12) Patent Application Publication
(10) Pub. No.: US 2022/0183425 A1
(43) Pub. Date: Jun. 16, 2022

(54) Military Thin-Lok Ribbons

(71) Applicant: Daniel Theadore Williams, Colorado Springs, CO (US)

(72) Inventor: Daniel Theadore Williams, Colorado Springs, CO (US)

(21) Appl. No.: 17/539,991

(22) Filed: Dec. 1, 2021

Related U.S. Application Data
(60) Provisional application No. 63/120,651, filed on Dec. 2, 2020.

(51) Int. Cl. A44C 3/00; G09F 3/20

(52) U.S. Cl. CPC A44C 3/004; G09F 3/207

(57) ABSTRACT

A thin military ribbon rack assembly includes a number of military ribbons, each consisting of the 3M SJ3056 dual lock fastener glued to the rear side of the ribbon assembly to adhere the ribbon assembly to the back plate. The back plate consists of an aluminum or plastic shim having the Velcro 3905 Loop material glued to one side. When the ribbons are pressed to the back plate, the dual lock fastener material on the ribbon locks the ribbon to the Velcro Loop material on the back plate. The wearer of the ribbon assembly can remove the ribbons and reinstall them to a larger size back plate as additional ribbons are earned.

### CROSS REFERENCE TO RELATED APPLICATIONS

This application is entitled to the benefit of provisional application No. 63/120,651, filed on Dec. 2, 2020.

### BACKGROUND OF THE INVENTION

The present invention relates to an assembly for conveniently attaching multiple ribbons to a military uniform.

### DESCRIPTION OF THE PRIOR ART

As military ribbons are earned, they are attached to a military uniform. Thin military ribbons are typically glued to a base panel that is then attached to the military uniform with pins or similar fasteners. Unfortunately, as additional ribbons are earned, the member must replace the existing ribbon rack assembly to accommodate additional ribbons. This invention addresses that problem by allowing thin military ribbons to be uniquely removed and replaced as necessary.

### SUMMARY OF THE INVENTION

The present invention relates to a thin military assembly. The device is comprised of a blank plastic or metal back plate with 3M 3509 loop material bonded to the front side to enable the ribbon assembly to be attached. The rear side of the back plate includes multiple fastening pins for attaching the assembly to the uniform. Magnetized name tag holders can be used in lieu of the fastening pins as an alternate attaching method. The ribbon assembly Part 3M 3506 is a steel metal shim wrapped in the ribbon material. The 3M 3506 is then attached to the back of the ribbon assembly. This allow the ribbons to be pressed to the back plate and fastened securely.

The greatest advantage of the invention is the ease of adding additional ribbons to the back plate. The user simply removes the ribbons from the discarded back plate and attach them, along with the additional earned ribbons to the newly acquired back plate.

Other features of the invention are further detailed in the description and drawings which illustrate the simple but effective design and use of the thin-lok military ribbon assembly.

### BRIEF DESCRIPTION OF THE DRAWINGS

FIG. 1—A steel metal shim is the material the ribbon fabric is attached to. It provides the shape and rigidity of the ribbon assembly.

FIG. 2—The ribbon fabric is a commercial product and is glued and wrapped around the metal shim.

FIG. 3—The 3M SJ3056 is one of a two-part low profile reclosable fastener. When glued to the back of the ribbon covered shim, it forms the ribbon assembly. Part two of fastener is described in FIG. 5.

FIG. 4—The ribbon assembly is comprised of the metal shim wrapped in fabric and attached to the 3MSJ3509 fastener. The ribbon assemblies are attached to the back plate assembly.

FIG. 4—The back plate is a 0.030″ thick plastic sheet or a 0.020 aluminum shim and forms the attaching back plate for the ribbons.

FIG. 5—The 3M SJ3059 is part two of the low profile reclosable fastener. When pressed together with part SJ3056, it forms a fastening feature. It is adhered to the back plate and makes up the attaching device for the ribbon assemblies.

FIG. 6—The back plate assembly is the combined plastic or metal shim and glued to part 3M SJ3059.

FIG. 7—The pin and clasp assembly consists of a pointed pin attached to a round plastic mounting tab and a retaining clasp. The pins are glued to the rear of the back plate assembly.

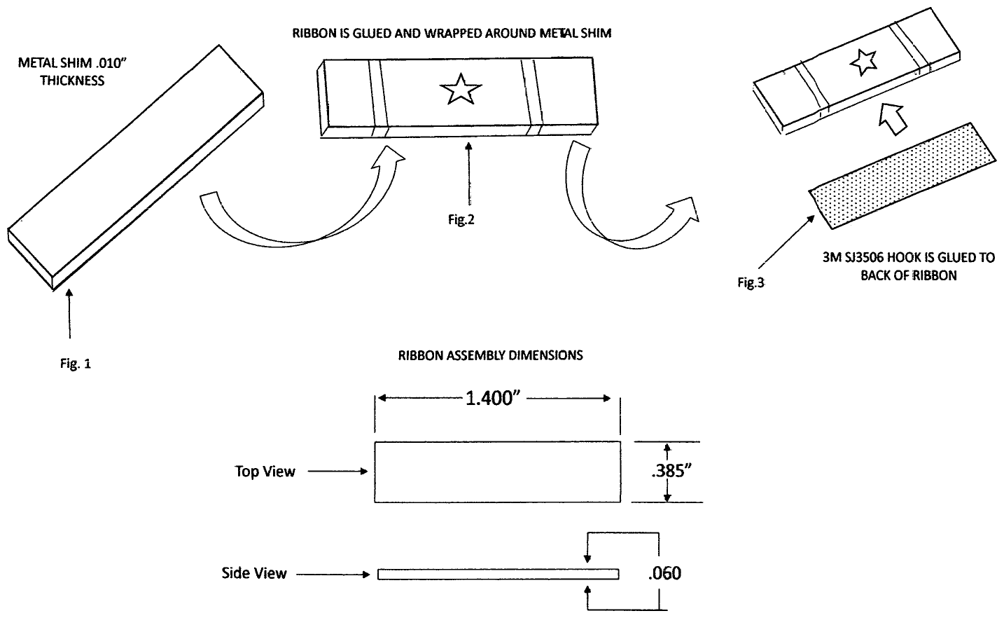

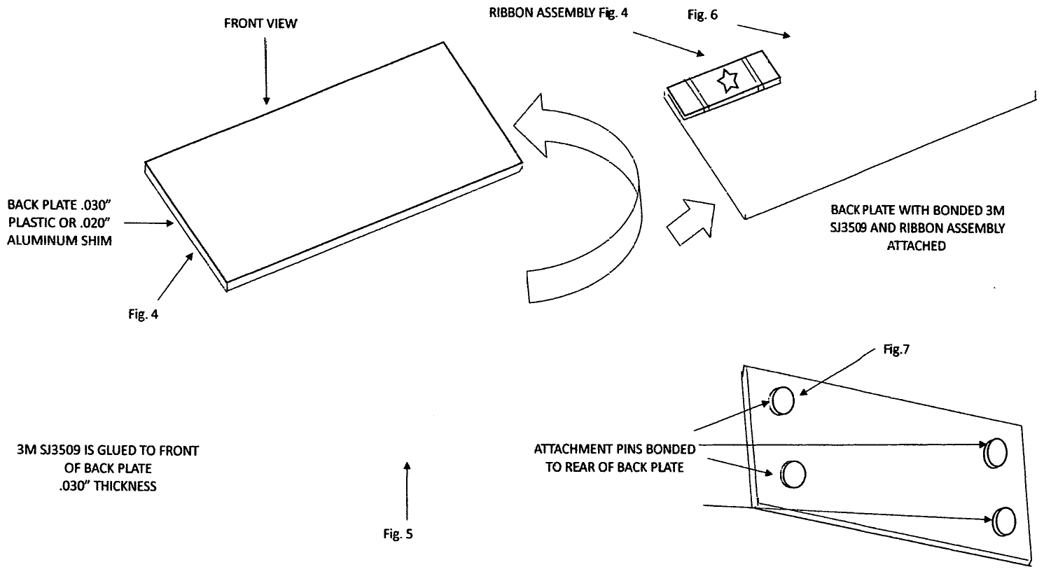

When the pins are pressed through the military member's clothing the metal clasp is attached to the pin and retains the ribbon rack on to the military uniform.

What is claimed is:

1. A flat military ribbon assembly constructed of a metal shim wrapped in ribbon material and a 3M 3506 material glued to the front side of the ribbon assembly.

2. A plastic or metal back plate bonded with 3M 3509 material for retaining the ribbon assemblies.
a. A fastening device attached to the rear surface of the back plate for attachment to the military uniform.

3. The fastening device is comprised of a pin and retaining clasp for attachment to the uniform.

4. The fastening device is alternatively comprised of magnetized name tag holders for attachment to the uniform.
